(19) United States
(12) Patent Application Publication
(10) Pub. No.: US 2004/0094898 A1
(43) Pub. Date: May 20, 2004

(54) Apparatus and method for inhibiting a flow of fluid through an interface between two joint members

(76) Inventor: Qiu Shi Zheng, Spring, TX (US)

Correspondence Address: Williams Morgan & Amerson P C, 10333 Richmond Drive Suite 1100, Houston, TX, 77042, US

(21) Appl. No.: 10/300,507

(22) Filed: Nov. 20, 2002

(51) Int. Cl. F16L 17/00

(52) U.S. Cl. 277/314

(57) ABSTRACT

A seal includes a bore seal portion comprising a first leg terminating in a first sealing profile and a second leg terminating in a second sealing profile, a crush seal portion, and a web extending between the crush seal portion and the bore seal portion. A method of installing a seal includes pressing a bore seal portion of the seal into a first bore of a first member such that a first sealing profile is urged against an inner surface of the first bore, pressing the bore seal portion of the seal into a second bore of a second member such that a second sealing profile is urged against an inner surface of the second bore and the first bore is generally aligned with the second bore, and crushing a crush seal portion of the seal within grooves defined by the first member and the second member.

### BACKGROUND OF THE INVENTION

1. Field of the Invention

This invention relates to the field of fluid seals and, in particular, to a seal for inhibiting a flow of fluid through an interface between two joint members.

2. Description of the Related Art

Many types of apparatus are provided with sealing components that inhibit a flow of fluid between one portion of the apparatus and another. Further, it is often desirable to retain a fluid within the apparatus an/or to inhibit fluid from entering the apparatus. Historically, elastomeric seals have often been used in these applications. Elastomeric seals, which are generally made of rubber or other polymeric materials, are compressed between surfaces of the apparatus to form a barrier to the flow of fluid. One common type of elastomeric seal is generally known as an O-ring and is used in many such applications.

Elastomeric seals generally work well in applications wherein the temperature and/or pressure of the fluid encountered by the seal are relatively low. However, in higher temperature and/or pressure applications, such as those encountered in oilfield applications, elastomeric seals generally less effective, as the physical properties of the material comprising the elastomeric seal may not be capable of withstanding the pressures and/or temperatures encountered. For example, the shear strength of an elastomeric seal may decrease when exposed to high temperature fluids and, thus, be incapable of inhibiting the flow of pressurized fluid. In such applications, metal seals may be used in place of elastomeric seals.

A variety of metal seal types may be used depending upon the application. For example, straight bore metal seals may be used to inhibit the flow of fluid from within the apparatus through an interface between two mating portions of the apparatus. Generally, such seals span the interface to be sealed and include two arms that terminate in sealing profiles. The sealing profiles press against internal surfaces of mated portions of the apparatus. As fluid pressure within the apparatus increases, the fluid urges the sealing profiles against the internal surfaces with greater force. Such seals are generally effective in inhibiting the flow of fluids having pressures of up to or exceeding 150 MPa.

However, straight bore metal seals used within the apparatus as described above are not well suited to inhibiting a flow of fluid through the interface from outside the apparatus. High pressure fluids external to the apparatus, seeping through the interface, may force the sealing profiles away from the surfaces on which they seal, thus allowing leakage of the fluid into the apparatus and possibly permanently deforming the seals.

In lower temperature applications, elastomeric seals may be used to inhibit the flow of fluid through the interface. However, in higher temperature applications, a crushable metallic seal may be used to inhibit the flow of fluid through the interface. Such seals generally have a compressive strength that falls short of the force used to clamp the mating portions together. The seal is disposed within mating grooves defined by the portions forming the joint, wherein the mated grooves are smaller than the seal prior to the mating portions being clamped. As the mating portions are clamped together, the seal is crushed within the mating grooves to seal the joint interface. The location of such crushable seals is away from the inside diameter of the bore, so the structural loading of the system may be greater. Accordingly, the equipment is generally larger to handle the increased loading, which increases the overall cost.

Combinations of multiple seals, however, may pose considerable installation problems. For example, it may be difficult in many situations to locate and retain multiple seals in the proper positions during installation, especially in subsea oilfield applications.

The present invention is directed to overcoming, or at least reducing, the effects of one or more of the problems set forth above.

### SUMMARY OF THE INVENTION

In one aspect of the present invention, a seal is provided. The seal includes a bore seal portion comprising a first leg terminating in a first sealing profile and a second leg terminating in a second sealing profile, a crush seal portion, and a web extending between the crush seal portion and the bore seal portion.

In another aspect of the present invention, a joint is provided. The joint includes a first member defining a first bore therethrough having an inner surface and a first groove therein, a second member mated with the first member and defining a second bore therethrough having an inner surface and a second groove therein, such that the first groove and the second groove are generally aligned and the first bore and the second bore are generally aligned, and a seal. The seal includes a bore seal portion comprising a first leg terminating in a first sealing profile in contact with the inner surface of the first bore and a second leg terminating in a second sealing profile in contact with the inner surface of the second bore, a crush seal portion disposed within the aligned first and second grooves, and a web extending between the crush seal portion and the bore seal portion.

In yet another aspect of the present invention, a method of installing a seal is provided. The method includes pressing a bore seal portion of the seal into a first bore of a first member such that a first sealing profile is urged against an inner surface of the first bore, pressing the bore seal portion of the seal into a second bore of a second member such that a second sealing profile is urged against an inner surface of the second bore and the first bore is generally aligned with the second bore, and crushing a crush seal portion of the seal within grooves defined by the first member and the second member.

In another aspect of the present invention, a method of inhibiting a flow of fluid through an interface between a first member and a second member is provided. The method includes contacting a first sealing profile of a bore seal portion with an inner surface of a bore of the first member, contacting a second sealing profile of the bore seal portion with an inner surface of a bore of the second member, and compressing a crush seal portion within grooves defined by the first member and the second member.

### BRIEF DESCRIPTION OF THE DRAWINGS

The invention may be understood by reference to the following description taken in conjunction with the accompanying drawings, in which the leftmost significant digit(s) in the reference numerals denote(s) the first figure in which the respective reference numerals appear, and in which:

FIG. 1 is a cross-sectional view of an illustrative embodiment of a seal according to the present invention;

FIG. 2 is a cross-sectional view of the seal of FIG. 1 being used to seal an illustrative embodiment of a joint according to the present invention;

FIGS. 3A-3C are cross-sectional views showing an illustrative embodiment of a method for installing the seal of FIG. 1 in the joint of FIG. 2;

FIG. 4 is a cross-sectional view of the joint of FIG. 2 in which the seal includes a segmented web;

FIG. 5 is a partial cross-sectional view of the joint of FIG. 2 in which the seal includes secondary sealing elements; and

FIG. 6 is a cross sectional view of an illustrative embodiment of an alternative seal and joint according to the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

Illustrative embodiments of the invention are described below. In the interest of clarity, not all features of an actual implementation are described in this specification. It will of course be appreciated that in the development of any such actual embodiment, numerous implementation-specific decisions must be made to achieve the developer's specific goals, such as compliance with system-related and business-related constraints, which will vary from one implementation to another. Moreover, it will be appreciated that such a development effort might be complex and time-consuming but would nevertheless be a routine undertaking for those of ordinary skill in the art having the benefit of this disclosure.

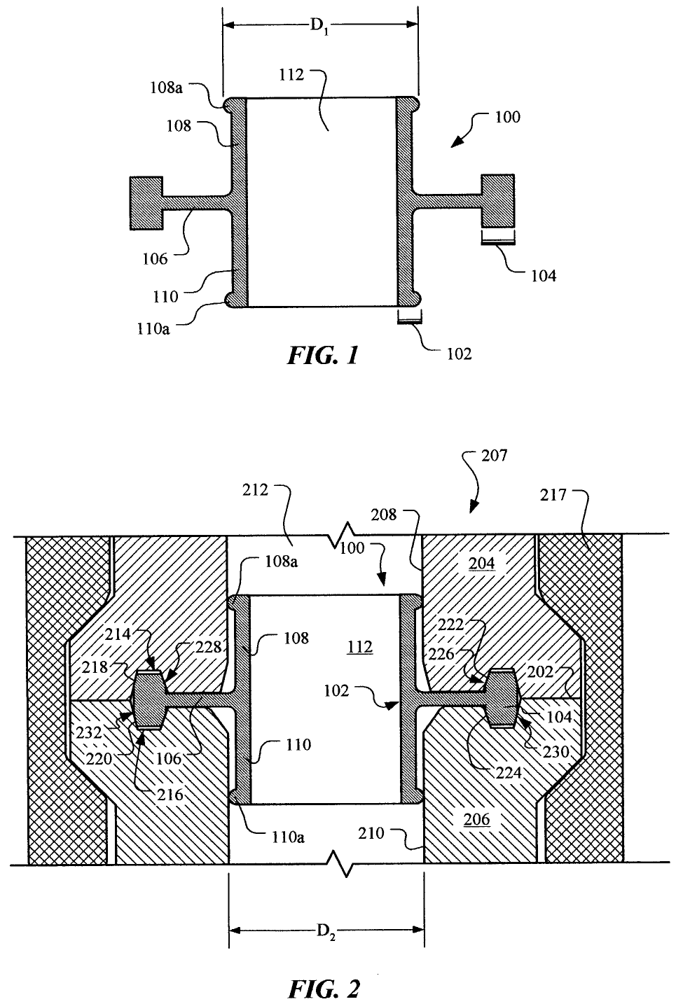

FIG. 1 provides a first illustrative embodiment of a seal 100 according to the present invention. The seal 100 includes a bore seal portion 102 connected to a crush seal portion 104 by a web 106. Thus, by way of example and illustration, the web 106 is but one means for connecting the bore seal portion 102 and the crush seal portion 104 employed in accordance with the present invention. The bore seal portion 102 further includes an upper leg 108 terminating in a sealing profile 108a and a lower second leg 110 terminating in a sealing profile 110a. The bore seal portion 102 defines a bore 112 through which fluids may pass.

FIG. 2 depicts the seal 100 in use to seal an interface 202 between an upper hub 204 and a lower hub 206 of a wellhead joint 207. While the seal 100 is described and illustrated herein in use in a wellhead, the present invention is not so limited. Rather, the seal 100 may be used to inhibit a flow of fluid through an interface between any two joint members that define a bore therein or therethrough. In the illustrated embodiment, the sealing profile 108a presses against an inner surface 208 of the upper hub 204 and the sealing profile 110a presses against an inner surface 210 of the lower hub 206 to inhibit a flow of fluid from within a bore 212, defined by the inner surfaces 208, 210, and into the interface 202.

When in a freestanding configuration (as shown in FIG. 1), the bore seal portion 102 has an outer diameter D₁ at the sealing profiles 108a, 110a that is slightly larger than an inner diameter D₂ of the bore 212. Thus, when installed as shown in FIG. 2, the sealing profiles 108a, 110a are in an interference relationship with the inner surfaces 208, 210. Fluid may flow through the bores 112, 212 but is inhibited from flowing through the interface 202 between the sealing profiles 108a, 110a and the inner surfaces 208, 210. Pressure from the fluid within the bores 112, 212 acts on the upper and lower legs 108, 110 to further urge the sealing profiles 108a, 110a against the inner surfaces 208, 210. Thus, by way of example and illustration, the bore seal portion 102 is but one means for inhibiting fluid from escaping from within the bore 212 through the interface 202 employed in accordance with the present invention.

Generally, the material for the bore seal portion 102 is selected according to the operating pressure of the fluid within the bores 112, 212. For example, if the fluid within the bores 112, 212 has an operating pressure greater than about 70 MPa, a material having a yield strength within a range of about 700 MPa to about 850 MPa may be selected. In one embodiment, the bore seal portion 102 comprises a material having a yield strength within a range of about 450 MPa and about 1,000 MPa. In situations wherein the fluid within the bores 112, 212 is particularly corrosive, some embodiments of the present invention may be made of nickel/chromium alloys, such as Inconel® (which comprises about 76 percent nickel and about 16 percent chromium in one form), beryllium copper (which comprises about 98 percent copper and about two percent beryllium in one form), or nickel/copper alloys, such as Monel® (which comprises about 67 percent nickel and about 30 percent copper in one form).

In one embodiment, the crush seal portion 104 is generally rectangular in cross-section, as shown in FIG. 1 and may comprise nickel/chromium alloys, such as Incoloy® 825 (which is a nickel-chromium-iron alloy comprising about 38 percent nickel and about 21 percent chromium in one form), type 316 stainless steel (which comprises about 17 percent nickel and 12 percent chromium in one form), and type 304 stainless steel (which comprises about 19 percent nickel and 10 percent chromium in one form). In one embodiment, the crush seal portion 104 comprises a material having a yield strength within a range of about 150 MPa and about 450 MPa. In some embodiments, the crush seal portion 104 may be coated with silver or polytetrafluoroethylene (or another fluoropolymer) to provide lubrication during installation and to inhibit galling. Of course, the cross-sectional configuration of the crush seal portion 104 may vary depending upon the application, i.e., it may have an oval or octagonal cross-sectional configuration.

During assembly (as will be described later), the crush seal portion 104 is compressed within an upper seal groove 214 and a lower seal groove 216, which are defined by the upper hub 204 and the lower hub 206, respectively, by a clamp 217. In the illustrated embodiment, the compressed crush seal portion 104 contacts the seal grooves 214, 216 along two outer contact areas 218, 220 and along two inner contact areas 222, 224 to inhibit the flow of fluid through the interface 202 and into the bores 112, 212. Thus, by way of example and illustration, the crush seal portion 104 is but one means for inhibiting fluid from entering the bore 212 through the interface 202 employed in accordance with the present invention.

In some embodiments, an inside diameter 226 of the crush seal portion 104 is slightly smaller than an outside diameter 228 of the contact areas 222, 224. An outside diameter 230 of the crush seal portion 104 has about the same dimension as an inside diameter 232 of the contact areas 218, 220. In this way, at mating there is initial interference at the contact areas 222, 224 and little or no interference at the contact areas 218, 220. During installation, the mating force at the contact areas 222, 224 initially urges the crush seal portion 104 radially outward. As installation continues, the crush seal portion 104 is crushed at the contact areas 218, 220. In this way, the crush seal portion 104 has improved external sealing capability and aids in creating an improved initial seal between the sealing profiles 108a, 110a and the inner surfaces 208, 210.

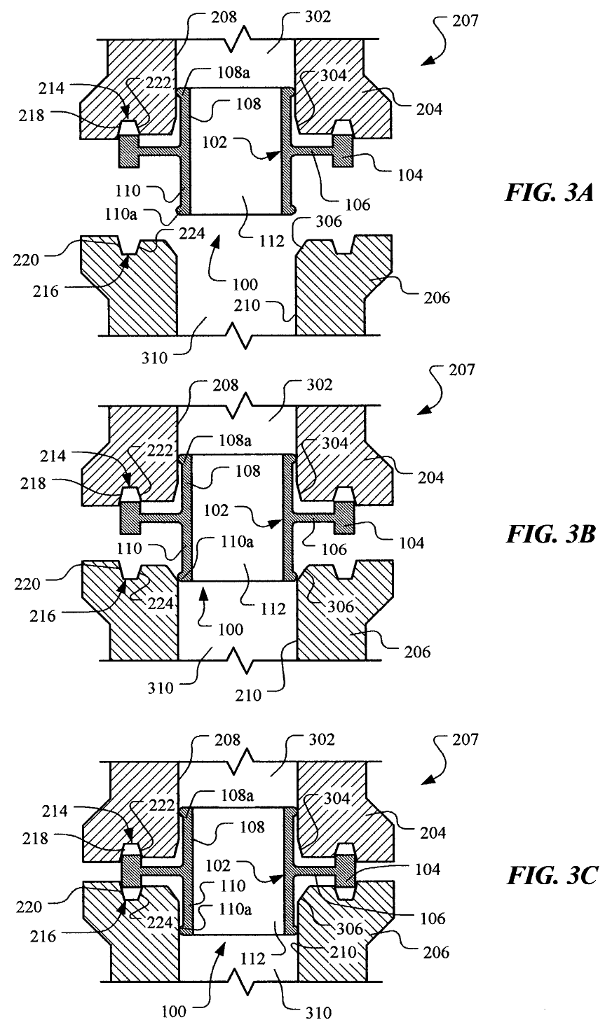

FIGS. 3A-3C illustrate one particular method of installing the seal 100 in the joint 207. As shown in FIG. 3A, the seal 100 is pressed into an upper portion 302 of the bore 212. In the illustrated embodiment, the upper hub 204 includes a chamfer 304 leading into the upper portion 302 of the bore 212 to aid in guiding the seal 100 therein. The seal 100 is held within the upper portion 302 by the interaction between the sealing profile 108a and the inner surface 208 of the upper hub 204. The upper hub 204, with the seal 100 engaged therewith, is lowered onto the lower hub 206, as shown in FIG. 3B, such that the sealing profile 110a engages the inner surface 210. The lower hub 206 includes a chamfer 306 leading into a lower portion 310 of the bore 212 to aid in guiding the seal 100 therein.

Once the seal 100 is positioned relative to the upper and lower hubs 204, 206 as shown in FIG. 3C, the hubs 204, 206 are brought together and clamped by the clamp 217, as shown in FIG. 2. As the hubs 204, 206 are brought together, the crush seal portion 104 is urged radially outwardly by contact with the hubs 204, 206 at the inner contact areas 222, 224, which forces the crush seal portion 104 into tighter contact with the hubs 204, 206 at the outer contact areas 218, 220. Thus, the outer contact areas 218, 220 and the inner contact areas 222, 224 form two seal barriers against the flow of fluid through the interface 202. If, during use, the outer contact areas 218, 220 should fail, the crush seal portion 104 will be forced inwardly by the pressure of the external fluid, creating a tighter seal at the inner contact areas 222, 224. The crush seal portion 104 also serves as an anchor for the seal 100, thus minimizing the movement of the bore seal portion 102 within the bore 212 and inhibiting axial movement of the bore seal portion 102 to reduce galling during operation.

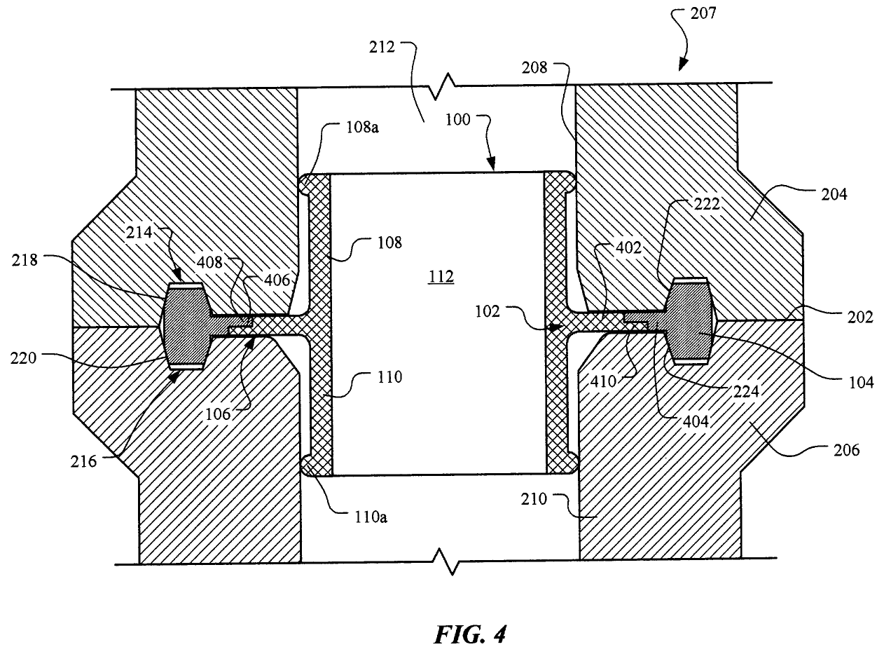

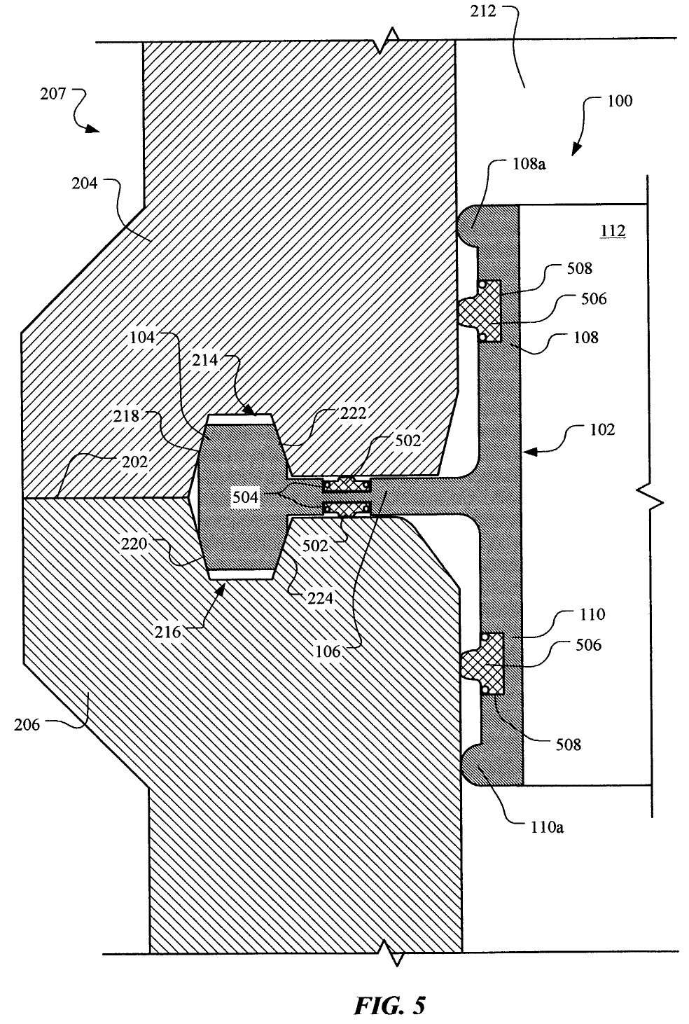

As illustrated in FIG. 4, the seal 100 may also comprise a segmented web 106. In the illustrated embodiment, the web 106 comprises a first portion 402 mated with a second portion 404 at a junction 406. A protrusion 410 of the first portion 402 extends beneath a protrusion 408 of the second portion 404 at the junction 406. While a lap-type junction 406 is illustrated in FIG. 4, the present invention is not so limited. Rather, any chosen junction type may be used to mate the first portion 402 and the second portion 404 of the web 106.

In the illustrated embodiment, the first portion 402 of the web 106 extends from the bore seal portion 102 and comprises the same material as the bore seal portion 102. Further, the second portion 404 of the web 106 extends from the crush seal portion 104 and comprises the same material as the crush seal portion 104. In the illustrated embodiment, as discussed above in relation to FIGS. 3A-3C, the seal 100 is held within the upper portion 302 of the bore 212 during installation by the interaction between the sealing profile 108a and the inner surface 208 of the upper hub 204. The second portion 404 of the web 106, and thus the crush seal portion 104, is supported in place by the first portion 402 of the web 106 during installation. Such an embodiment provides one way for different materials to be used for the bore seal portion 102 and the crush seal portion 104.

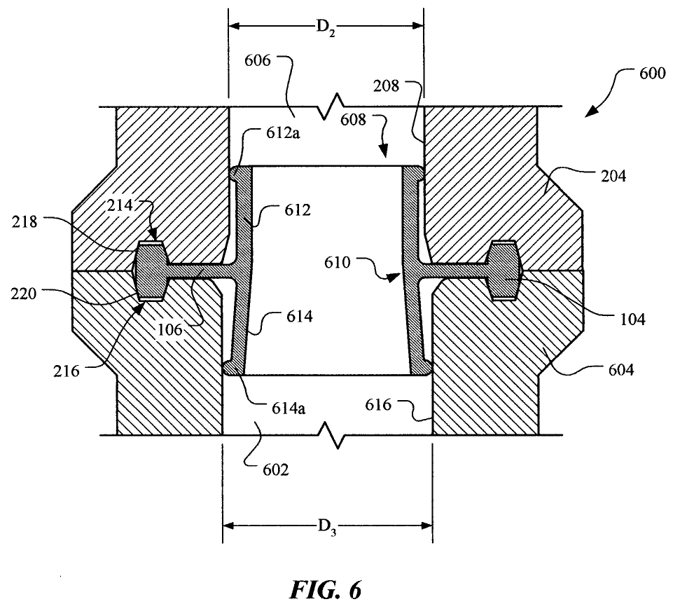

The seal 100 may also include secondary sealing elements, as shown in FIG. 5, which is a cross-sectional view of the left portion of the joint 207. In the illustrated embodiment, the seal 100 includes secondary sealing elements 502 disposed within grooves 504 defined by the web 106, between the hubs 204, 206 and the web 106. When the seal 100 is installed as illustrated, the secondary sealing elements 502 inhibit the flow of external fluid that may penetrate the contact areas 218, 220, 222, 224. Further, in the illustrated embodiment, the seal 100 further comprises secondary sealing elements 506 disposed within grooves 508 defined by the bore seal portion 102, between the legs 108, 110 and the inner surfaces 208, 210. Thus, the secondary sealing elements inhibit the flow of internal fluid that may penetrate between the sealing profiles 108a, 110a and the inner surfaces 208, 210.

The secondary sealing elements 502, 506 illustrated in FIG. 5 comprise an elastomeric material, such as hydrogenated nitrile rubber (HNBR), polyetheretherketone (PEEK), polytetrafluoroethylene (PTFE), or the like. While the secondary sealing elements 502, 506 are illustrated as having a particular shape, the invention is not so limited. Rather, the sealing elements 502, 506 may have any chosen shape. Further, the secondary sealing elements may be disposed in grooves (not shown) defined by the hubs 204, 206, between the web 106 and the hubs 204, 206, rather than in the grooves 504, 508, as illustrated in FIG. 5. While the embodiment illustrated in FIG. 5 includes both the secondary sealing elements 502 and the secondary sealing elements 506, the scope of the present invention encompasses the seal 100 comprising the secondary sealing elements 502 and/or the secondary sealing elements 506.

In some situations, it may be desirable to seal a joint in which a bore diameter of one of the joint members is different from a bore diameter of the other joint member, as illustrated in FIG. 6. The illustrative embodiment of FIG. 6 differs from the illustrative embodiment of FIG. 2 only in that a diameter D₃ of a bore 602 of a lower hub 604 is larger than a diameter D₂ of a bore 606 of the upper hub 204. In the FIG. 2 embodiment, the diameter D₂ of the bore 212 is generally constant through the hubs 204, 206. A seal 608 comprises a bore seal portion 610, the crush seal portion 104, and the web 106 extending therebetween. The bore seal portion 610 comprises a first leg 612 terminating in a first sealing profile 612a and a second leg 614 terminating in a second sealing profile 614a. In the illustrated embodiment, the second leg 614 is outwardly canted with respect to the first leg 612 so that the sealing profile 614a may contact an inner surface 616 of the larger diameter bore 602.

It should be noted that, while the seal installation method shown in FIGS. 3A-3C is described in relationship to the illustrative seal embodiment shown in FIG. 2, any of the illustrative seal embodiments disclosed herein may be installed by the method shown in FIGS. 3A-3C. Further, the illustrative embodiment shown in FIG. 6 may include aspects of the illustrative embodiments shown in FIGS. 4 and 5, e.g., the segmented web 106, the lap-type junction 406 of the web 106, and/or the secondary sealing elements 502, 506.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

What is claimed is:

1. A seal, comprising:
a bore seal portion comprising a first leg terminating in a first sealing profile and a second leg terminating in a second sealing profile;
a crush seal portion; and
a web extending between the crush seal portion and the bore seal portion.

2. A seal, according to claim 1, wherein the web further comprises a first portion extending from the bore seal portion and a second portion extending from the crush seal portion, the first portion and the second portion of the web being mated together.

3. A seal, according to claim 2, wherein the first and second portions of the web are mated at a lap-type junction.

4. A seal, according to claim 1, wherein the bore seal portion comprises a material having a yield strength within a range of about 450 MPa and about 1,000 MPa.

5. A seal, according to claim 1, wherein the bore seal portion further comprises a material selected from the group consisting of a nickel/chromium alloy, beryllium copper, or a nickel/copper alloy.

6. A seal, according to claim 1, wherein the crush seal portion further comprises a nickel/chromium alloy.

7. A seal, according to claim 1, wherein the crush seal portion comprises a material having a yield strength within a range of about 150 MPa and about 450 MPa.

8. A seal, according to claim 1, further comprising a pair of secondary sealing elements extending from the web.

9. A seal, according to claim 8, wherein at least one of the secondary sealing elements comprises a material selected from the group consisting of hydrogenated nitrile rubber, polyetheretherketone, and polytetrafluoroethylene.

10. A seal, according to claim 1, further comprising a pair of secondary sealing elements extending from the bore seal portion.

11. A seal, according to claim 10, wherein at least one of the secondary sealing elements comprises a material selected from the group consisting of hydrogenated nitrile rubber, polyetheretherketone, and polytetrafluoroethylene.

12. A seal, according to claim 1, wherein the second leg is canted with respect to the first leg.

13. A joint, comprising:
a first member defining a first bore therethrough having an inner surface and a first groove therein;
a second member mated with the first member and defining a second bore therethrough having an inner surface and a second groove therein, such that the first groove and the second groove are generally aligned and the first bore and the second bore are generally aligned; and
a seal comprising:
a bore seal portion comprising a first leg terminating in a first sealing profile in contact with the inner surface of the first bore and a second leg terminating in a second sealing profile in contact with the inner surface of the second bore;
a crush seal portion disposed within the aligned first and second grooves; and
a web extending between the crush seal portion and the bore seal portion.

14. A joint, according to claim 13, wherein the inner surface of the first member further comprises a chamfer for guiding the seal into the first bore.

15. A joint, according to claim 13, wherein the inner surface of the second member further comprises a chamfer for guiding the seal into the second bore.

16. A joint, according to claim 13, wherein the web further comprises a first portion extending from the bore seal portion and a second portion extending from the crush seal portion, the first portion and the second portion of the web being mated together.

17. A joint, according to claim 16, wherein the first and second portions of the web are mated at a lap-type junction.

18. A joint, according to claim 13, wherein the bore seal portion comprises a material having a yield strength within a range of about 450 MPa and about 1,000 MPa.

19. A joint, according to claim 13, wherein the bore seal portion further comprises a material selected from the group consisting of a nickel/chromium alloy, beryllium copper, or a nickel/copper alloy.

20. A joint, according to claim 13, wherein the crush seal portion further comprises a nickel/chromium alloy.

21. A joint, according to claim 13, wherein the crush seal portion comprises a material having a yield strength within a range of about 150 MPa and about 450 MPa.

22. A joint, according to claim 13, further comprising a pair of secondary sealing elements extending from the web.

23. A joint, according to claim 22, wherein at least one of the secondary sealing elements comprises a material selected from the group consisting of hydrogenated nitrile rubber, polyetheretherketone, and polytetrafluoroethylene.

24. A joint, according to claim 13, further comprising a pair of secondary sealing elements extending from the bore seal portion.

25. A joint, according to claim 24, wherein at least one of the secondary sealing elements comprises a material selected from the group consisting of hydrogenated nitrile rubber, polyetheretherketone, and polytetrafluoroethylene.

26. A joint, according to claim 13, wherein the first bore and the second bore have approximately the same diameter.

27. A joint, according to claim 13, wherein:
the first bore and the second bore have different diameters; and
the second leg is canted with respect to the first leg.

28. A joint, according to claim 13, further comprising a clamp engaged with the first member and the second member for clamping the first member against the second member.

29. A method of installing a seal, comprising:
pressing a bore seal portion of the seal into a first bore of a first member such that a first sealing profile is urged against an inner surface of the first bore;
pressing the bore seal portion of the seal into a second bore of a second member such that a second sealing profile is urged against an inner surface of the second bore and the first bore is generally aligned with the second bore; and
crushing a crush seal portion of the seal within grooves defined by the first member and the second member.

30. A method, according to claim 29, wherein pressing the bore seal portion of the seal into the first bore further comprises guiding the first sealing profile along a chamfer leading into the first bore.

31. A method, according to claim 29, wherein pressing the bore seal portion of the seal into the second bore further comprises guiding the second sealing profile along a chamfer leading into the second bore.

32. A method, according to claim 29, wherein crushing the seal portion further comprises urging the crush seal portion radially outwardly within the grooves.

33. A method, according to claim 29, further comprising clamping the first member and the second member together.

34. A method of inhibiting a flow of fluid through an interface between a first member and a second member, comprising:
contacting a first sealing profile of a bore seal portion with an inner surface of a bore of the first member;
contacting a second sealing profile of the bore seal portion with an inner surface of a bore of the second member; and
compressing a crush seal portion within grooves defined by the first member and the second member.

35. A method, according to claim 34, further comprising clamping the first member and the second member together.

36. An apparatus for sealing an interface between a first member defining a first bore therethrough and a second member defining a second bore therethrough, comprising:
means for inhibiting a first fluid from escaping from within the bores through the interface;
means for inhibiting a second fluid from entering the bores through the interface; and
means for connecting the means for inhibiting the first fluid and the means for inhibiting the second fluid.

37. An apparatus, according to claim 36, wherein the means for inhibiting the first fluid comprises a bore seal portion comprising a first leg terminating in a first sealing profile in contact with an inner surface of the first bore and a second leg terminating in a second sealing profile in contact with an inner surface of the second bore.

38. An apparatus, according to claim 36, wherein the means for inhibiting the second fluid comprises a crush seal portion disposed within aligned grooves defined by the first member and the second member.

39. An apparatus, according to claim 36, wherein the means for connecting further comprises a web extending between the means for inhibiting the first fluid and the means for inhibiting the second fluid.

40. An apparatus, according to claim 36, wherein the first and second bores have approximately the same diameter.

41. An apparatus, according to claim 36, wherein the first and second bores have different diameters.
